(19) United States
(12) Patent Application Publication
(10) Pub. No.: US 2022/0359991 A1
(43) Pub. Date: Nov. 10, 2022

(54) TRIFURCATED ANTENNA RADIATOR AND SYSTEM

(71) Applicant: 2J ANTENNAS USA, CORPORATION, Gilbert, AZ (US)

(72) Inventor: Javier Ruben Flores-Cuadras, Chandler, AZ (US)

(73) Assignee: 2J ANTENNAS USA, CORPORATION, Gilbert, AZ (US)

(21) Appl. No.: 17/738,294

(22) Filed: May 6, 2022

Related U.S. Application Data
(60) Provisional application No. 63/316,260, filed on Mar. 3, 2022.
(60) Provisional application No. 63/185,180, filed on May 6, 2021.

(51) Int. Cl. H01Q 13/20; H01Q 1/38; H01Q 1/48; H01Q 5/47; H01Q 9/40

(52) U.S. Cl. CPC H01Q 13/206; H01Q 1/38; H01Q 1/48; H01Q 5/47; H01Q 9/40; H01Q 21/068

(57) ABSTRACT

A trifurcated antenna radiator is disclosed. The trifurcated antenna radiator includes a first radiator, a second radiator, and a third radiator. The first and second radiators are coupled to a negative terminal and the third radiator is coupled to a positive terminal. The first radiator includes a first arched element having a first end and a second end and a first apex therebetween. The second radiator includes second arched element having a third end and a fourth end and a second apex therebetween. The first and second radiators may be symmetrical or asymmetrically with respect to each other. The third radiator may be symmetrical or asymmetrical.

### CROSS-REFERENCE TO RELATED APPLICATIONS

This application claims benefit of priority with U.S. Provisional Application Ser. No. 63/185,180, filed May 6, 2021; this application further claims benefit of priority with U.S. Provisional Application Ser. No. 63/316,260, filed Mar. 3, 2022; the entire contents of which both are hereby incorporated by reference.

### BACKGROUND

### Field of the Invention

This invention relates to antennas; more particularly, a trifurcated antenna radiator.

### Description of the Related Art

Many MIMO or ARRAY systems tend to occupy a relatively large space due to the new B71 Band (600 MHz) that one North America carrier recently added to the cellular network offering. At the same time, other bands have been added in the higher portion of the sub-6 GHz FR1 spectrum, increasing the complexity of size reduction in MIMO systems.

There is a need for an improved antenna radiator which can have its size reduced while still being able to occupy a wide frequency spectrum.

### SUMMARY

The disclosure concerns a trifurcated antenna radiator. The trifurcated antenna radiator comprises a first radiator, a second radiator, and a third radiator. The first and second radiators are coupled to a negative terminal and the third radiator is coupled to a positive terminal. The first radiator includes a first arched element having a first end and a second end and a first apex therebetween. The second radiator includes second arched element having a third end and a fourth end and a second apex therebetween. The first and second radiators may be symmetrical or asymmetrically with respect to each other. The third radiator may be symmetrical or asymmetrical.

The trifurcated antenna radiator provides for a smaller form factor while still operating in a relatively wide bandwidth. In some embodiments, space of reduction of 66% was achieved. Return Loss parameter for a working frequency from 600 MHz to 6000 MHz can average −5 dB or better while providing good VSWR covering 100% of the required bandwidth. Efficiency can average 50% or better across the band of interest while having good isolation with the worst being measured at −12 dB at 630 MHz. Envelope correlation coefficient was measured at a maximum of 0.4.

The same design as disclosed herein can be adapted to cover other frequencies for different communication standards like ISM, Wi-Fi, Bluetooth, GNSS, or the like.

### BRIEF DESCRIPTION OF THE DRAWINGS

Other features, combinations, and embodiments will be appreciated by one having the ordinary level of skill in the art of antenna upon a thorough review of the following details and descriptions, particularly when reviewed in conjunction with the drawings, wherein:

FIG. 1 shows a front view of a trifurcated antenna radiator in accordance with a first illustrated embodiment;

FIG. 2A shows a front view of a dissection the trifurcated antenna radiator according to the first illustrated embodiment;

FIG. 2B shows a current flow of the trifurcated antenna radiator according to the first illustrated embodiment;

FIG. 3A shows resonances for high frequency matching according to the first illustrated embodiment;

FIG. 3B shows resonances for mid frequency matching according to the first illustrated embodiment;

FIG. 4A shows a front view of a third radiator according to the first illustrated embodiment;

FIG. 4B shows a front view of an alternate third radiator according to the first illustrated embodiment;

FIG. 4C shows a front view of an alternate third radiator according to the first illustrated embodiment;

FIG. 5A shows a front view of symmetrical first and second radiators according to the first illustrated embodiment;

FIG. 5B shows a front view of alternate symmetrical first and second radiators according to the first illustrated embodiment;

FIG. 5C shows a front view of alternate symmetrical first and second radiators according to the first illustrated embodiment;

FIG. 6A shows a front view of asymmetrical first and second radiators according to the first illustrated embodiment;

FIG. 6B shows a front view of alternate asymmetrical first and second radiators according to the first illustrated embodiment;

FIG. 6C shows a front view of alternate asymmetrical first and second radiators according to the first illustrated embodiment;

FIG. 7 shows a top view of a MIMO system in accordance with a second illustrated embodiment; and

FIG. 8 shows perspective view of a MIMO system in accordance with a third illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “arched element” means an element having an upwardly curve with an apex between two end points. The arched element may be symmetrical or asymmetrical.

The “trifurcated antenna radiator” means an antenna radiator divided into three radiators.

Unless explicitly defined herein, terms are to be construed in accordance with the plain and ordinary meaning as would be appreciated by one having skill in the art.

### General Description of Embodiments

In one embodiment, a trifurcated antenna radiator is disclosed. The trifurcated antenna radiator comprises a substrate, a positive terminal, a negative terminal, a first radiator, a second radiator and a third radiator. The substrate comprises a proximal end and a distal end opposite the proximal end, a first longitudinal half disposed at the proximal end and a second longitudinal half disposed at the distal end, both the first and second longitudinal halves comprising a first side, a second side, and a central portion extending along the substrate. The positive terminal is disposed on the first longitudinal half at the central portion. The negative terminal is disposed on the first longitudinal half at the central portion between the positive terminal and the proximal end.

The first radiator is disposed on the first side and comprises a first arched element having a first end and a second end and a first apex therebetween. The first end is coupled to the negative terminal and the first apex being is disposed on the second longitudinal half, the first radiator further comprises a first terminal element coupled to the second end wherein at least a portion of the first terminal element is vertically disposed between the negative terminal and the proximal end.

The second radiator is disposed on the second side and comprises a second arched element having a third end and a fourth end and a second apex therebetween, the third end being coupled to the negative terminal and the second apex being disposed on the second longitudinal half. The second radiator further comprises a second terminal element coupled to the fourth end wherein at least a portion of the second terminal element is vertically disposed between the negative terminal and the proximal end.

The third radiator is coupled to the positive terminal and extends between the first and second radiators from the positive terminal to the distal end. The third radiator comprises a width wherein the width at the first longitudinal half is less than the width at the second longitudinal half.

In some embodiments, the first radiator and the second radiator may be symmetrical. In other embodiments, the first and second radiators may be asymmetrical.

In some embodiments, the third radiator may comprise a central monopole. The third radiator may be physically separate from the first and second radiators. The third radiator may be symmetrical or asymmetrical.

In another embodiment, a trifurcated antenna radiator is disclosed. The trifurcated antenna radiator comprises a substrate, a positive terminal and negative terminal disposed on the substrate, and a first, second and third radiator disposed on the substrate. The substrate comprises a proximal end and a distal end opposite the proximal end, a first longitudinal half disposed at the proximal end and a second longitudinal half disposed at the distal end. Both the first and second longitudinal halves comprise a first side, a second side, and a central portion extending along the substrate. The positive terminal is disposed on the first longitudinal half. The negative terminal disposed on the first longitudinal half between the positive terminal and the proximal end. The first radiator is disposed on the first side, and comprises a first arched element having a first end and a second end and a first apex therebetween. The first end is coupled to the negative terminal. The second radiator is disposed on the second side, and comprises a second arched element having a third end and a fourth end and a second apex therebetween. The third end is coupled to the negative terminal. The third radiator is coupled to the positive terminal, and extends between the first and second radiators from the positive terminal to the distal end.

In some embodiments, the first radiator and the second radiator may be symmetrical. In other embodiments, the first and second radiators may be asymmetrical.

In some embodiments, the third radiator may comprise a central monopole. The third radiator may be physically separate from the first and second radiators. The third radiator may be symmetrical or asymmetrical.

In some embodiments, the positive terminal and the negative terminal may be disposed on the central portion.

In some embodiments, the first apex may be disposed on the second longitudinal half.

In some embodiments, the first radiator may further comprise a first terminal element coupled to the second end wherein at least a portion of the first terminal element is vertically disposed between the negative terminal and the proximal end.

In some embodiments, the second apex may be disposed on the second longitudinal half.

In some embodiments, the second radiator may further comprise a second terminal element coupled to the fourth end wherein at least a portion of the second terminal element is vertically disposed between the negative terminal and the proximal end.

In some embodiments, the third radiator may further comprise a width wherein the width at the first longitudinal half is less than the width at the second longitudinal half.

In another embodiment, a MIMO system is disclosed. The MIMO system comprises a plurality of substrate portions, wherein each of the plurality of substrate portions comprises a proximal end and a distal end opposite the proximal end, a first longitudinal half disposed at the proximal end and a second longitudinal half disposed at the distal end, and both the first and second longitudinal halves comprising a first side, a second side, and a central portion extending along the substrate. The MIMO system further comprises a plurality of positive terminals, wherein each of the positive terminals is disposed on one of the plurality of substrate portions on the first longitudinal half, a plurality of negative terminals, wherein each of the negative terminals is disposed on one of the plurality of substrate portions on the first longitudinal half between the positive terminal and the proximal end, and a plurality of trifurcated antenna radiators, wherein each of the plurality of trifurcated antenna radiators is disposed on one of the plurality of substrate portions. Each of the plurality of trifurcated antenna radiators comprises a first radiator disposed on the first side, the first radiator comprising a first arched element having a first end and a second end and a first apex therebetween, the first end being coupled to the negative terminal, a second radiator disposed on the second side, the second radiator comprising a second arched element having a third end and a fourth end and a second apex therebetween, the third end being coupled to the negative terminal, and a third radiator coupled to the positive terminal, the third radiator extending between the first and second radiators from the positive terminal to the distal end.

In some embodiments, the plurality of substrate portions may comprise a single substrate. In other embodiments, the plurality of substrate portions may comprise physically separate substrates.

In some embodiments, the first radiator and the second radiator may be symmetrical. In other embodiments, the first and second radiators may be asymmetrical.

In some embodiments, the third radiator may comprise a central monopole. The third radiator may be physically separate from the first and second radiators. The third radiator may be symmetrical or asymmetrical.

In some embodiments, the positive terminal and the negative terminal may be disposed on the central portion.

In some embodiments, the first apex may be disposed on the second longitudinal half.

In some embodiments, the first radiator may further comprise a first terminal element coupled to the second end wherein at least a portion of the first terminal element is vertically disposed between the negative terminal and the proximal end.

In some embodiments, the second apex may be disposed on the second longitudinal half.

In some embodiments, the second radiator may further comprise a second terminal element coupled to the fourth end wherein at least a portion of the second terminal element is vertically disposed between the negative terminal and the proximal end.

In some embodiments, the third radiator may further comprise a width wherein the width at the first longitudinal half is less than the width at the second longitudinal half.

### Manufacturing

Generally, substrates are made of industry standard material such as ceramic, plastic polymer, or low-cost fiberglass. Examples may include FR4, Kapton or Pyralux with printed circuit design affixed thereto. Otherwise, they can be fabricated in accordance with the level and knowledge of one having skill in the art.

Radiators may be fabricated by etching an antenna element pattern in a metal trace bonded to an insulating dielectric substrate, such as a printed circuit board.

Each of the components of the antenna and related system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

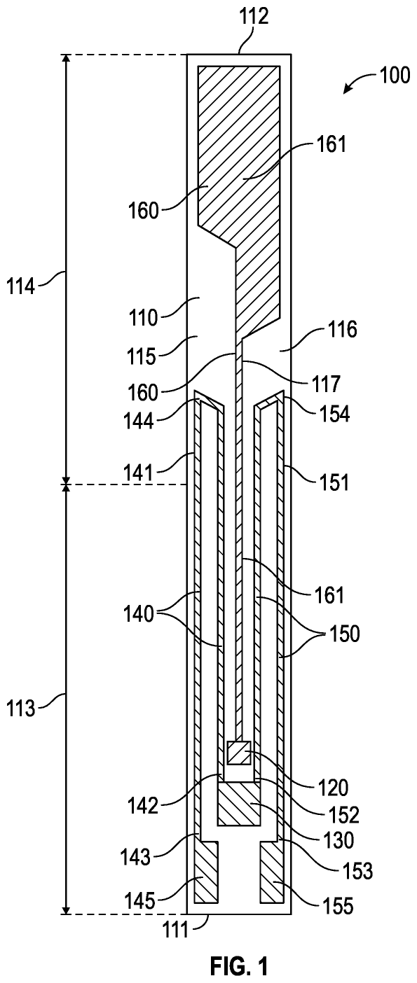

FIG. 1 shows a front view of a trifurcated antenna radiator (100) in accordance with a first illustrated embodiment. The trifurcated antenna radiator comprises a substrate (110) having a proximal end (111), a distal end (112) opposite the proximal end, a first longitudinal half (113) disposed at the proximal end, and a second longitudinal half (114) disposed at the distal end. The substrate further comprises a first side (115), a second side (116), and a center portion (117) disposed between he first and second sides. A positive terminal (120) is disposed at the center portion on the first longitudinal half. Disposed below the positive terminal is a negative terminal (130) such that the negative terminal is disposed between the positive terminal and the proximal end. Generally, the negative terminally is centrally aligned with the positive terminal.

A first radiator (140) is coupled to the negative terminal (130) and is disposed on the first side (115) of the substrate (110). The first radiator comprises a first arched element (141) having a first end (142), a second end (143), and a first apex (144) disposed on the first arched element between the first and second ends. The first and second ends are each disposed on the first side and are further disposed on the first longitudinal half (113). The first side is coupled to the negative terminal. In some embodiments, the first apex is disposed on the second longitudinal half (114). In other embodiments, the first apex is disposed on the first longitudinal half. Coupled to the second end of the first arched element is a first terminal element (145). In some embodiments, the first terminal element is disposed on the first side and extends towards the second side (116) such that at least a portion of the first terminal element is disposed vertically under the negative terminal. As shown, the first radiator is disposed on the first side and no portion of the first radiator is disposed on the second side. The first radiator is characterized as being a negative resonator due to be coupled with the negative terminal.

A second radiator (150) is coupled to the negative terminal (130) and is disposed on the second side (116) of the substrate (110). The second radiator comprises a second arched element (151) having a third end (152), a fourth end (153), and a second apex (154) disposed on the second arched element between the third and fourth ends. The third and fourth ends are each disposed on the second side (116) and are further disposed on the first longitudinal half (113). The third end is coupled to the negative terminal. In some embodiments, the second apex is disposed on the second longitudinal half (114). In other embodiments, the second apex is disposed on the first longitudinal half. Coupled to the fourth end of the second arched element is a second terminal element (155). In some embodiments, the second terminal element is disposed on the second side and extends towards the first side (115) such that at least a portion of the second terminal element is disposed vertically under the negative terminal. As shown, the second radiator is disposed on the second side and no portion of the second radiator is disposed on the first side. The second radiator is characterized as being a negative resonator due to be coupled with the negative terminal. The first and second radiators are shown being symmetrical with respect to each other. In other embodiments, the first and second radiators may be asymmetrical with respect to each other.

A third radiator (160) is coupled to the positive terminal (120) and extends towards the distal end (112) where a portion of the third radiator is disposed between the first and second radiators (140; 150), and more specifically the first and second arched elements (144; 154). The third radiator is disposed on both the first longitudinal half (114) and the second longitudinal half (115). The third radiator generally comprises varying width (161) such that the largest width of the third radiator on the first longitudinal half is less than the largest width of the third radiator on the second longitudinal half. The third radiator may occupy the second longitudinal half at each of the first side (115), central portion (117), and first side (116). The third radiator is shown having an asymmetrical topology. Other shaped topologies may also be used as can be appreciated by one having skill in the art. The third radiator can be characterized as a central monopole and comprises a positive polarization due to being coupled with the positive terminal.

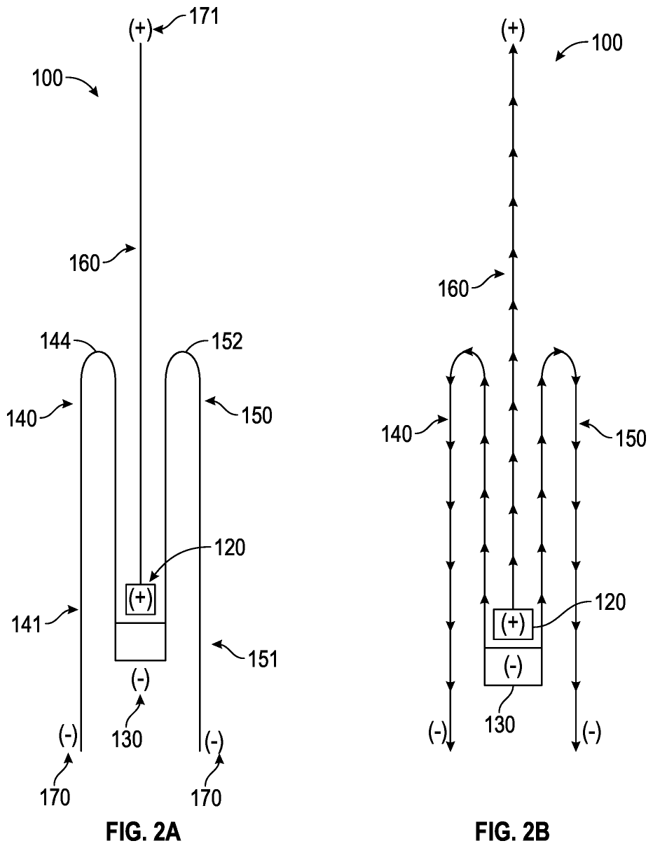

FIG. 2A shows a front view of a dissection the trifurcated antenna radiator (100) according to the first illustrated embodiment. The trifurcated antenna radiator comprises a first radiator (140) and a second radiator (150) each coupled to a negative terminal (130). A positive terminal (120), physically and electrically separate from the negative terminal, is positioned above the negative terminal and disposed between the first and second radiators. The first and second radiators comprise a negative polarity (170). A third radiator (160) coupled to the positive terminal comprises a positive polarity (171). In some embodiments, the first and second radiators provide low resonance and the third radiator provides mid resonances.

The first and second radiators (140; 150) each comprise a first ached element (141) and second arched element (151), respectively. The first arched element comprises a first apex (144) and the second arched element comprises a second apex (154). The first apex and second apex are each disposed above and to a side of the positive terminal and negative terminal.

FIG. 2B shows a current flow of the trifurcated antenna radiator (100) according to the first illustrated embodiment. The trifurcated antenna radiator comprises a first radiator (140), a second radiator (150), and a third radiator (160). The first and second radiators are each coupled to a negative terminal (130) and the third radiator is coupled to a positive terminal (120). Current from the positive terminal travels along the third radiator. Current from the negative terminal travels form the negative terminal along both the first and second radiators.

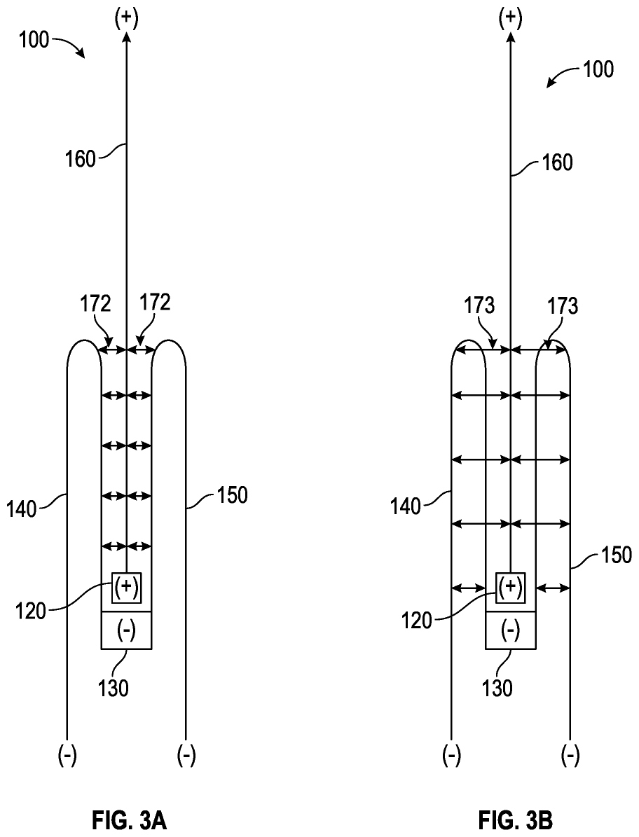

FIGS. 3A and 3B show resonances for high and mid frequency matching according to the first illustrated embodiment. A trifurcated antenna radiator (100) comprises a third radiator (160) coupled to a positive terminal (120) and a first and second radiators (140; 150) coupled to a negative terminal (130). A portion of the third radiator is disposed between the first and second radiators, and a portion of the third antenna extends above the first and second radiators. High frequency resonance and matching (172) is shown above the positive terminal and between an innermost of the first and second radiators where the portion of the third radiator is disposed therebetween. Mid frequency resonance and matching (173) is shown above the positive terminal and between an outermost of the first and second radiators where the portion of third radiator is disposed therebetween. Low frequency resonance is produced along a full extension from an end of the third radiator to ends of the first and second radiators.

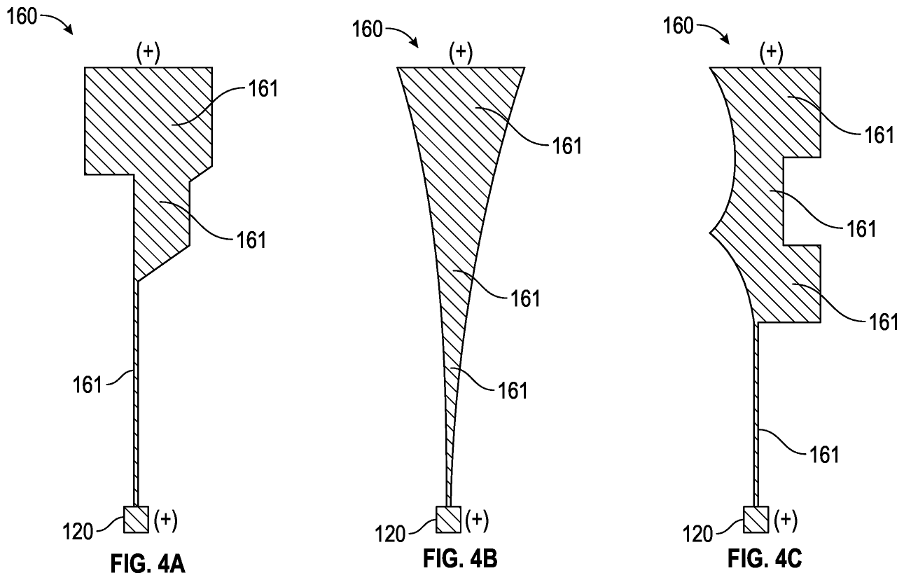

FIG. 4A-4C show a front view of various embodiments of a third radiator (160) according to the first illustrated embodiment. The third radiator can be characterized as a central monopole and may comprise symmetrical and asymmetrical topologies. The third radiator is coupled to a positive terminal (120) and comprises a varying width (161) along the third radiator. Generally, the width closer to the positive terminal will be less than the width of the third radiator further from the positive terminal. The third radiator can take a plurality of shapes in order to obtain a required bandwidth or resonance as can be appreciated by one having skill in the art. The positive terminal can be configured to couped to a center conductor of an RF cable via soldering.

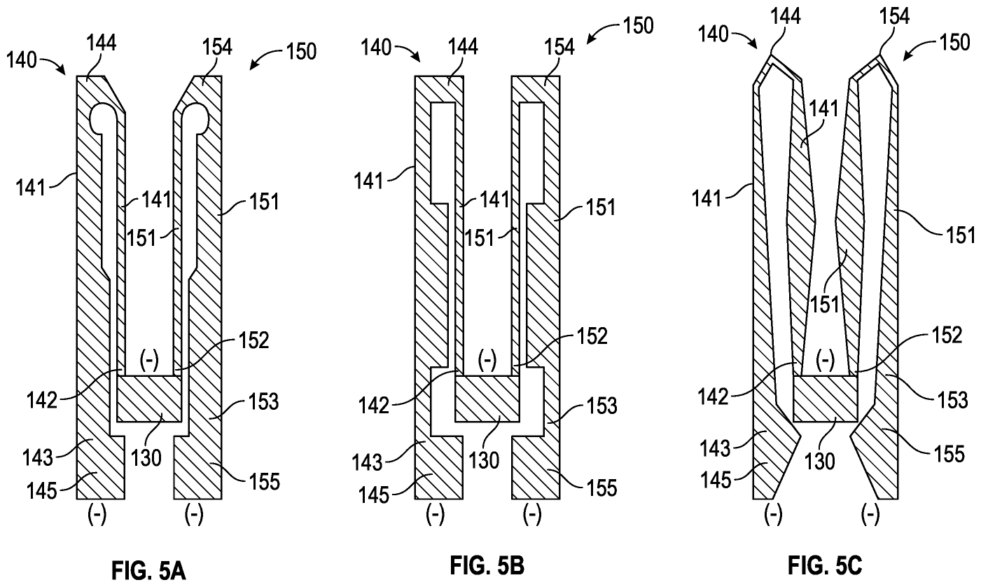

FIG. 5A-5C show a front view of various symmetrical first and second radiators (140; 150) according to the first illustrated embodiment. The first and second radiators are each coupled to a negative terminal (130). The first radiator comprises a first arched element (141). The first arched element is coupled to the negative terminal at a first end (142) and extends above the negative terminal towards a first apex (144), wherein the first arched element extends downwards towards a second end (143) past the negative terminal. Coupled to the second end is a first terminal element (145). In some embodiments, the first terminal end extends towards the second radiator such that a portion of the first terminal element is disposed vertically under the negative terminal.

The second radiator (150) comprises a second arched element (151). The second arched element is coupled to the negative terminal (130) at a third end (152) and extends above the negative terminal towards a second apex (154), wherein the second arched element extends downwards towards a fourth end (153) past the negative terminal. Coupled to the fourth end is a second terminal element (155). In some embodiments, the second terminal end extends towards the first radiator such that a portion of the second terminal element is disposed vertically under the negative terminal. The negative terminal can be configured to solder with an outer conductor of an RF cable.

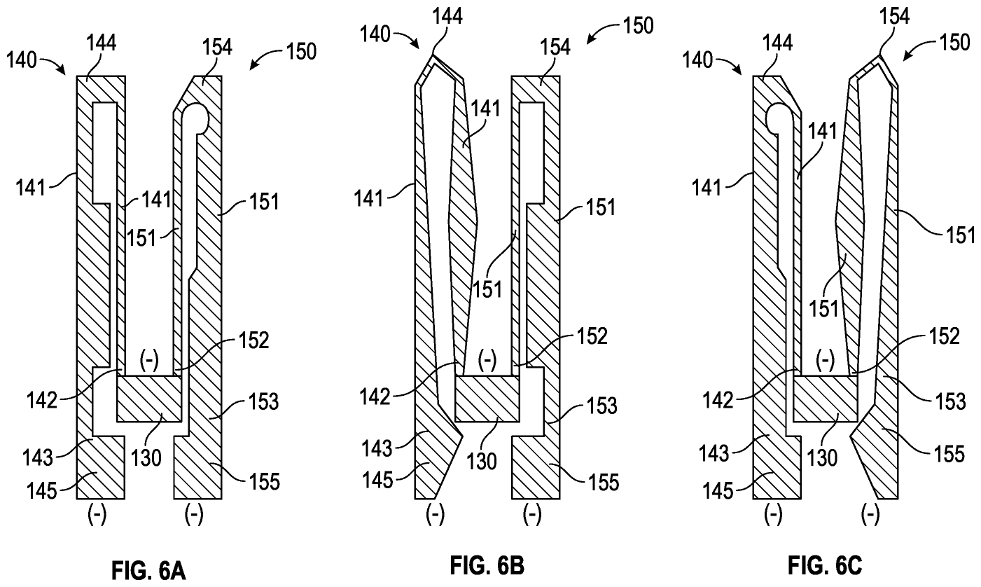

FIG. 6A-6C show a front view of various asymmetrical first and second radiators according to the first illustrated embodiment. The first and second radiators are each coupled to a negative terminal (130). The first radiator comprises a first arched element (141). The first arched element is coupled to the negative terminal at a first end (142) and extends above the negative terminal towards a first apex (144), wherein the first arched element extends downwards towards a second end (143) past the negative terminal. Coupled to the second end is a first terminal element (145). In some embodiments, the first terminal end extends towards the second radiator such that a portion of the first terminal element is disposed vertically under the negative terminal.

The second radiator (150) comprises a second arched element (151). The second arched element is coupled to the negative terminal (130) at a third end (152) and extends above the negative terminal towards a second apex (154), wherein the second arched element extends downwards towards a fourth end (153) past the negative terminal. Coupled to the fourth end is a second terminal element (155). In some embodiments, the second terminal end extends towards the first radiator such that a portion of the second terminal element is disposed vertically under the negative terminal. The negative terminal can be configured to solder with an outer conductor of an RF cable.

### Second Illustrated Embodiment

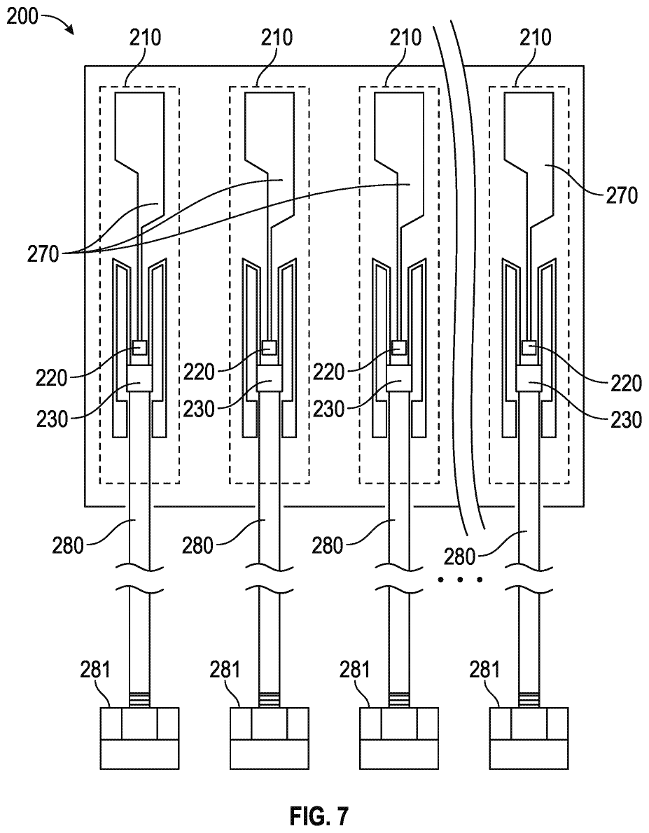

FIG. 7 shows a top view of a MIMO system (200) in accordance with a second illustrated embodiment. The MIMO system comprises a plurality of trifurcated antenna radiators (270) disposed on the plurality of substrate portions (210) wherein the plurality of substrate portions is disposed on a common, single substrate. Each of the plurality of substrate portions includes an RF cable (280) coupled to both a positive terminal (220) and a negative terminal (230) via an inner conductor and outer conductor, respectively, of the RF cable. Disposed at an end of the RF cable is an RF connector (281) for coupling to a radio. The MIMO system disclosed herein having a single, common substrate allows for ease of manufacturing and integration while having a relatively larger footprint. As shown, the MIMO system comprises four trifurcated antenna radiators. It can be appreciated that other number of trifurcated antenna radiators may also be used.

### Third Illustrated Embodiment

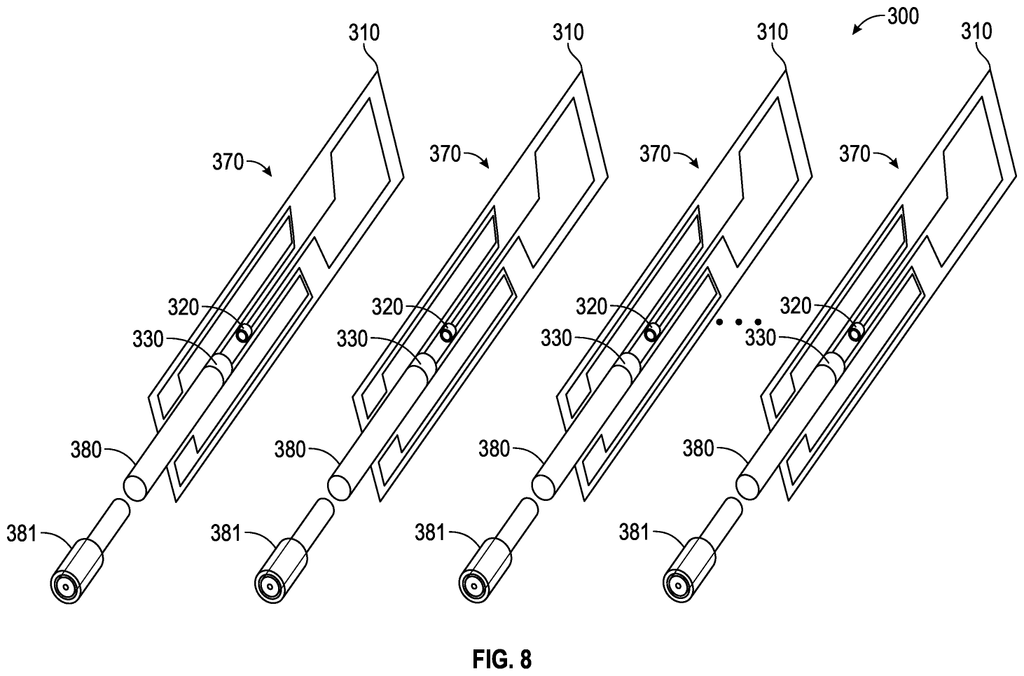

FIG. 8 shows perspective view of a MIMO system (300) in accordance with a third illustrated embodiment. The MIMO system comprises a plurality of trifurcated antenna radiators (370) disposed on the plurality of substrate portions (310) wherein the plurality of substrate portions comprises individually separate substrates. Each of the plurality of substrate portions includes an RF cable (380) coupled to both a positive terminal (320) and a negative terminal (330) via an inner conductor and outer conductor, respectively, of the RF cable. Disposed at an end of the RF cable is an RF connector (381) for coupling to a radio. The MIMO system disclosed herein having individually separate substrates allows for a smaller footprint while having a relatively less easier means of manufacture and integration. Preferably, each of the individual substrates may be at least 10 mm apart from neighboring individual substrates. As shown, the MIMO system comprises four trifurcated antenna radiators. It can be appreciated that other number of trifurcated antenna radiators may also be used.

### Feature List

trifurcated antenna radiator (100)
substrate (110)
proximal end (111)
distal end (112)
first longitudinal half (113)
second longitudinal half (114)
first side (115)
second side (116)
central portion (117)
positive terminal (120; 220; 320)
negative terminal (130; 230; 330)
first radiator (140)
first arched element (141)
first end (142)
second end (143)
first apex (144)
first terminal element (145)
second radiator (150))
second arched element (151)
third end (152)
fourth end (153)
second apex (154)
second terminal element (155)
third radiator (160)
width (161)
negative polarity (170)
positive polarity (171)
high frequency resonance (172)
mid frequency resonance (173)
MIMO system (200; 300)
plurality of substrate portions (210; 310)
plurality of trifurcated antenna radiators (270; 370)
RF cable (280; 380)
RF connector (281; 381)

What is claimed is:

1. A trifurcated antenna radiator, comprising:
a substrate having a proximal end and a distal end opposite the proximal end, a first longitudinal half disposed at the proximal end and a second longitudinal half disposed at the distal end, both the first and second longitudinal halves comprising a first side, a second side, and a central portion extending along the substrate;
a positive terminal disposed on the first longitudinal half at the central portion;
a negative terminal disposed on the first longitudinal half at the central portion between the positive terminal and the proximal end;
a first radiator disposed on the first side, the first radiator comprising a first arched element having a first end and a second end and a first apex therebetween, the first end being coupled to the negative terminal and the first apex being disposed on the second longitudinal half, the first radiator further comprising a first terminal element coupled to the second end wherein at least a portion of the first terminal element is vertically disposed between the negative terminal and the proximal end;
a second radiator disposed on the second side, the second radiator comprising a second arched element having a third end and a fourth end and a second apex therebetween, the third end being coupled to the negative terminal and the second apex being disposed on the second longitudinal half, the second radiator further comprising a second terminal element coupled to the fourth end wherein at least a portion of the second terminal element is vertically disposed between the negative terminal and the proximal end; and
a third radiator coupled to the positive terminal, the third radiator extending between the first and second radiators from the positive terminal to the distal end, the third radiator comprising a width wherein the width at the first longitudinal half is less than the width at the second longitudinal half.

2. The trifurcated antenna radiator of claim 1, wherein the third radiator is physically separate from the first and second radiators.

3. A trifurcated antenna radiator, comprising:
a substrate having a proximal end and a distal end opposite the proximal end, a first longitudinal half disposed at the proximal end and a second longitudinal half disposed at the distal end, both the first and second longitudinal halves comprising a first side, a second side, and a central portion extending along the substrate;
a positive terminal disposed on the first longitudinal half;
a negative terminal disposed on the first longitudinal half between the positive terminal and the proximal end;
a first radiator disposed on the first side, the first radiator comprising a first arched element having a first end and a second end and a first apex therebetween, the first end being coupled to the negative terminal;
a second radiator disposed on the second side, the second radiator comprising a second arched element having a third end and a fourth end and a second apex therebetween, the third end being coupled to the negative terminal; and
a third radiator coupled to the positive terminal, the third radiator extending between the first and second radiators from the positive terminal to the distal end.

4. The trifurcated antenna radiator of claim 3, wherein the third radiator is physically separate from the first and second radiators.

5. The trifurcated antenna radiator of claim 3, wherein the positive terminal and the negative terminal are disposed on the central portion.

6. The trifurcated antenna radiator of claim 3, wherein the first apex is disposed on the second longitudinal half.

7. The trifurcated antenna radiator of claim 3, the first radiator further comprising a first terminal element coupled to the second end wherein at least a portion of the first terminal element is vertically disposed between the negative terminal and the proximal end.

8. The trifurcated antenna radiator of claim 3, wherein the second apex is disposed on the second longitudinal half.

9. The trifurcated antenna radiator of claim 3, the second radiator further comprising a second terminal element coupled to the fourth end wherein at least a portion of the second terminal element is vertically disposed between the negative terminal and the proximal end.

10. The trifurcated antenna radiator of claim 3, the third radiator further comprising a width wherein the width at the first longitudinal half is less than the width at the second longitudinal half.

11. A MIMO system, comprising:
a plurality of substrate portions, wherein each of the plurality of substrate portions comprises:
a proximal end and a distal end opposite the proximal end,
a first longitudinal half disposed at the proximal end and a second longitudinal half disposed at the distal end, and
both the first and second longitudinal halves comprising a first side, a second side, and a central portion extending along the substrate;
a plurality of positive terminals, wherein each of the positive terminals is disposed on one of the plurality of substrate portions on the first longitudinal half;
a plurality of negative terminals, wherein each of the negative terminals is disposed on one of the plurality of substrate portions on the first longitudinal half between the positive terminal and the proximal end; and
a plurality of trifurcated antenna radiators, wherein each of the plurality of trifurcated antenna radiators is disposed on one of the plurality of substrate portions, each of the plurality of trifurcated antenna radiators comprising:
a first radiator disposed on the first side, the first radiator comprising a first arched element having a first end and a second end and a first apex therebetween, the first end being coupled to the negative terminal,
a second radiator disposed on the second side, the second radiator comprising a second arched element having a third end and a fourth end and a second apex therebetween, the third end being coupled to the negative terminal, and
a third radiator coupled to the positive terminal, the third radiator extending between the first and second radiators from the positive terminal to the distal end.

12. The MIMO system of claim 11, wherein the plurality of substrate portions comprises a single substrate.

13. The MIMO system of claim 11, wherein the plurality of substrate portions comprises physically separate substrates.

14. The MIMO system of claim 11, wherein the third radiator is physically separate from the first and second radiators.

15. The MIMO system of claim 11, wherein the positive terminal and the negative terminal are disposed on the central portion.

16. The MIMO system of claim 11, wherein the first apex is disposed on the second longitudinal half.

17. The MIMO system of claim 11, the first radiator further comprising a first terminal element coupled to the second end wherein at least a portion of the first terminal element is vertically disposed between the negative terminal and the proximal end.

18. The MIMO system of claim 11, wherein the second apex is disposed on the second longitudinal half.

19. The MIMO system of claim 11, the second radiator further comprising a second terminal element coupled to the fourth end wherein at least a portion of the second terminal element is vertically disposed between the negative terminal and the proximal end.

20. The MIMO system of claim 11, the third radiator further comprising a width wherein the width at the first longitudinal half is less than the width at the second longitudinal half.
